(19) United States
(12) Patent Application Publication
(10) Pub. No.: US 2014/0004928 A1
(43) Pub. Date: Jan. 2, 2014

(54) DETERMINING GAMBLERS BEHAVIORAL RULES AND WALLET

(71) Applicant: STICS, INC., San Diego, CA (US)

(72) Inventors: Karen Christiana Joiner-Congleton, Ramona, CA (US); Daniel Shoham, Encinitas, CA (US)

(21) Appl. No.: 13/933,561

(22) Filed: Jul. 2, 2013

Related U.S. Application Data
(60) Provisional application No. 61/666,991, filed on Jul. 2, 2012.

(51) Int. Cl. G07F 17/32

(52) U.S. Cl. CPC G07F 17/3239
USPC 463/25

(57) ABSTRACT

According to one aspect of the present disclosure, a method and technique for determining gamblers behavioral rules and wallet is disclosed. The method includes an algorithm or process that utilizes information showing the actual behavior of a large number of gamblers that are presumed to follow similar behavioral rules to surmise those rules. A stopping vector may be defined and estimated for a select gambler. The algorithm is then utilized to establish the wallet for each gambler who follows similar behavioral rules.

### BACKGROUND

Gaming enterprises use various methods to reward and provide incentives to their customers. These methods may include providing complimentaries (commonly referred to as “comps”) and other types of incentives to increase customer traffic and stimulate specific customer behavior. Marketing to targeted customers may also take into account the value of the customer to the business. For example, an enterprise may value its customers based on the amount of revenue the enterprise is likely to make from the customer's gaming activity. Identifying customers that generate more revenue for the enterprise allows the enterprise to identify and target those customers for particular incentives and to maintain the loyalty of such customers to the enterprise.

### BRIEF SUMMARY

According to one aspect of the present disclosure a method and technique for establishing a wallet or financial capacity/value/worth for a gambler is disclosed. The method includes an algorithm or process that utilizes information showing the actual behavior of a large number of gamblers that are presumed to follow similar behavioral rules to surmise those rules. The algorithm is then utilized to establish the wallet for each gambler who follows similar behavioral rules.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of an exemplary use of the invention of the present disclosure;

FIG. 2 is an embodiment of a process according to the present disclosure; and

FIG. 3 is a diagram illustrating an embodiment of an exemplary application of a correlation algorithm according to the present disclosure.

### DETAILED DESCRIPTION

The actions of an individual gambler when in a casino, or other gambling environment, are presumed to be governed by behavioral rules. If those rules are known, then it is possible to probabilistically ascertain the likely losses the gambler will incur during a visit. We define these expected losses; measured in units of currency, as the gambler's “wallet.” Such knowledge is useful for multiple constituencies:
Casinos: Prioritizing marketing resources to the most profitable gamblers.
Gamblers: Understanding the effective cost of their behavior.
Regulators, social scientists, help groups, and other protective bodies: Metering the connection between behavior elements and expected losses.

In this disclosure, casinos prioritizing marketing resources is emphasized. In general, the behavioral rules of any individual gambler are unknown to the casino, and potentially even to the gambler. Whereas the actual sequence of gambles can often be observed through technological and other tracking methods, there is no previously known way to surmise the behavioral rules from the actual events. While the actual events demonstrate what the behavioral rules drove the gambler to do under the specific circumstances of their gambles turning out as they did, it is unknown what the gambler would have done had their gambles turned out differently. Consequently, while the actual losses (or gains) incurred by the gambler during a visit may be known; the expected losses under the behavioral rules driving the gambler may not be known.

It is those unknown expected losses, defined here as the “gambler's wallet,” not actual losses (or gains), that are most relevant to the various constituencies identified. Throughout this disclosure, it is assumed that the expected outcome of each individual gamble favors the casino. This assumption is accurate in substantially all commercial casinos. We use the word “expected” to indicate the probabilistic expected value outcome of a gamble and the word “actual” to indicate the specific outcome of a specific gamble. A $1.00 gambled at a slot machine, for example, can simultaneously have an expected outcome of a $0.04 loss, and an actual outcome of a $1000 gain. As per our assumption, the expected outcome of any one gamble and any sequence of gambles, regardless of governing behavioral rules is always a loss to the gambler, whereas the actual outcome may be either a loss or a gain.

An algorithm and process according to the present disclosure utilizes information showing the actual behavior of a large number of gamblers that are presumed to follow similar behavioral rules to surmise those rules. The algorithm is then utilized to establish the wallet for each gambler who follows similar behavioral rules.

### Example Use of the Invention

A casino has a data base of past visitors showing the gambling sequence of each visitor in each past visit. The casino wishes to engage a mail marketing campaign targeting the highest wallet past visitors.

Utilizing the invention, the algorithm is applied, with the aid of a computer, to each gambling sequence of each past visitor, to establish the likely behavioral rules of that gambler. Once the likely behavioral rules are established, using standard probabilistic or Monte Carlo techniques and the known (to the casino) distribution of potential outcomes of each gamble, the wallet is computed. The casino then engages the mail marketing campaign to those past visitors with the highest wallet.

An alternative, potentially more sophisticated, use of the invention in this mail marketing example would involve the establishment, through standard modeling techniques, of the change in behavioral rules that could be instigated by targeted offers and the mathematical optimization of offers to individual visitors so as to maximize expected gain for the casino. For instance, if a statistical model establishes that time-limited visitors (see below for definition of time-limited), are likely to substantially extend their time limit if they are given a complimentary hotel room, then an optimization can be developed to identify those visitors where the casino would incrementally gain by make such an offer in their mail campaign.

Existing methods used by casinos to determine wallet largely relies on the outcome of their actual prior gambling sequence. Three common evaluation methods are “Actual,” “Theoretical,” and “ADW (average daily worth).” These methods and their respective weaknesses and systematic biases relative to the invention are indicated below. By way of example, we consider two extreme caricatures of gambler behavioral rules: Dollar-limited gambling, where a gambler begins with a certain amount of money and will continue to gamble, regardless of how long it takes, until, inevitably, the entire amount is lost; and Time-limited gambling, where a gambler will engage in a pre-determined finite number of gambles and will then depart regardless of outcome.

Actual: Under this method, the actual loss incurred by a gambler in a past visit is the presumed value of their wallet. This method is accurate for Dollar-limited gambling behavior rules since the actual losses equal the starting amount regardless of the individual gambles and will be so again in a repeat visit under the same behavioral rules. However, for all other gambling rules, this method has obvious weaknesses. Gambling sequences governed by plausible behavioral rules typically will have a non-zero probability of an outcome that is a gain to the gambler. Obviously, such an outcome is a meaningless estimation wallet (as stated above, the expected outcome regardless of behavioral rules always favors the casino). Since, for the population as a whole (assuming it is large enough), in accordance with the Law of Large Numbers, the total actual losses must (statistically) equal the expected losses; to account for those gamblers with winning visits, the losses of those gamblers with losing visits must be biased to compensate. Hence, the use of actual past outcome generates a systematic over-estimate bias of wallet size for gamblers with past losing visits and is meaningless for gamblers with past winning visits.

Theoretical: Under this method, each gamble is valued as the expected outcome of that gamble, regardless of the actual outcome. The wallet of a past visit is the sum of the value of all gambles taken during the visit. This method is accurate for strict Time-limited gambling behavior rules since a repeat visit under the same rules will generate the same expected theoretical value. However, this method is entirely meaningless for Dollar-limited and any other rules where the gambling decisions are influenced by the outcome of prior gambles in the same sequence. Since the theoretical losses of a Dollar-limited gambler can exceed the actual dollar limit (for example, if the gambler begins with a win, and continue on to lose all his money—which now exceeds the actual starting amount), but can never be less than that amount, the theoretical method has a systematic bias to over-estimate Dollar-limited gamblers.

ADW (Average Daily Worth): ADW is a deterministic formula that combines the actual and theoretical value of a gambler during a 24 hour period. Since the formula, as well as the time period, is arbitrary, it fails to account for any specific behavioral rules; but can be a useful intermediate point between the two methods it combines. The system provides a specific systematic bias against any specific behavioral rules, depending on the formula used and the behavioral rules.

The invented algorithm predicates on a behavioral rules model where the gambler has a plurality of stopping reasons available with each stopping reason gauged by a single continuous parameter. The gambler will continue to engage a sequence of largely similar gambles until the earlier of the stopping reasons actualizes. Statistical techniques, utilizing the recorded gambling sequence of a statistically significant sample of gamblers believed to be governed by related behavioral rules, are employed to estimate the actual stopping parameters and hence establish the behavioral rules.

For example: A gambler at a slot machine is making bets of $1.00 each every 10 seconds. The gambler will continue doing so until they run out of money, run out of time, or wins a sizable jackpot and lose interest in further gambling for this visit. This situation can be described as one where the behavioral rule is summarized by 3 stopping reasons and an associated parameter for each one: Running out of money (with the associated parameter being the starting amount), running out of time (with the associated parameter being the available time), and winning a sizable jackpot (with the associated parameter being the minimum amount of a jackpot that would trigger a termination of the gambling sequence).

We define the Stopping Vector as the ordered set of the parameters associated with each of the available stopping reasons.

In the example above, the Stopping Vector will have 3 components with the first and third component having units of money and the second component having units of time. For example: Stopping Vector=[$100, 3 hours, $10,000]. The algorithm of the present disclosure involves three steps:
1) Define the Stopping Vector;
2) Use any statistical or modeling technique to estimate the Stopping Vector; and
3) Use the Stopping Vector to compute, approximate, or simulate, the wallet.

A more detailed example implementation of the steps of the invented algorithm is as follows:
1) Identify the available stopping reasons and define the associated parameters.
2) For each member of a statistically significant sample of past gambling sequences that is presumed to follow similar behavioral rules, surmise the most likely stopping reason.
   a) A potential method for such surmising would be to identify indicators that a reason might be active (for example, when the deposited dollars in a slot machine have been exhausted). See below for more details.
   b) Another potential method would be to establish a population correlation between the various stopping parameters and declare the component that most exceeds the correlation as the stopping reason.
3) For each of the available stopping reasons, from among those past gambling sequences determined to have been stopped by that stopping reason (in step #2, above), evaluate the most likely value of the associated parameter.
   a) A potential method of such evaluation would be to compute the average value of the parameter at the stopping time among all gambling sequences determined to be stopped for that reason.
   b) The ordered set of all evaluated parameters forms the Un-calibrated Stopping Vector.
4) Compute the likely outcome of a gambling sequence that follows the behavioral rules indicated by the un-calibrated stopping vector.
   a) A potential method of such evaluation would be to compute the probabilistic outcome of a sequence of gambles that is stopped by the stopping reasons at the points as indicated by the un-calibrated stopping vector.
   b) Another potential method would be to perform a computerized Monte Carlo simulation of a statistically significant number of experiments, with a computerized random number generator utilized to simulate individual gambles, where each experiment is stopped when any of the stopping reasons as indicated by the un-calibrated stopping vector is reached. The likely outcome is the computed average of the gambling losses (or gains) of all simulated gambling sequence.
5) Optionally, calibrate the Un-calibrated Stopping vector by multiplying all components by the same scalar constant, so as to match a pre-determined requirement.
   a) A potential requirement would be that the likely outcome (as computed in step #4, above) be equal to the actual average outcome of all past gambling sequence used (in step #2, above).
   b) A potential technique to identify the scalar constant that will meet the requirement would be to use a standard numerical analysis technique, such as the bisection algorithm, Newton's method, or the Secant method.
6) The Calibrated Stopping Vector will thus represent the surmised behavioral rules.

Example Algorithms to Surmise Stopping Reasons:

Step #2 in the invention description above requires the use of an algorithm to statistically surmise the actual stopping reason for individual past gambling sequences. Several classes of such methods are provided here, by way of example: Indicator-based algorithms, Maximum Likelihood algorithms, and Correlation algorithms. Each method is described in some details below.

Indicators-based algorithms: This method identifies cues (called “indicators”), such as round amounts, or individual deposits to identify plausible stopping reasons. A governing table of indicators and the logical steps to determine their relevance may be used to define an algorithm of this class. An example of such a table is provided here:

TABLE 1

| Stopping Reason | Observable Parameters | Comments |
|---|---|---|
| Out of cash (OOCh) | All casino currency | Gambler might have additional cash available, |
| | used. | but if stopping time exactly coincides with a |
| | | zero balance, we declare OOC. |
| Stop Loss (SLo) | NO OOCh AND | Losses to gambler reached a level where |
| | Casino is winning AND | gambler decides to stop (either by prior or |
| | { SLo indicator OR | impromptu decision). |
| | NO OuT indicator } | |
| Quit While Ahead (QWA) | Casino is losing AND | Winning by gambler reached a level where |
| | { QWA indicator OR | gambler decides to stop (either by prior or |
| | NO OuT indicator } | impromptu decision). |
| Out of Time (OuT) | NO OOCh AND | Gambler reached the end of the time available |
| | NO SLO indicator AND | to gamble. Gambler quits whether ahead or |
| | NO QWA indicator AND | behind. |
| | OuT indicator | |
| Random Event (RE) | Depends on event | Gambling might be stopped by random |
| | | outside events (power outage, emergency, |
| | | etc.) that can be modeled stochastically as a |
| | | probability per unit time (similar to an |
| | | exponential decay process). |
| Other (O) | None of the above | All other reasons. |
| | applies | |

Maximum Likelihood Algorithms: This class of algorithms assumes that the stopping reason parameters are themselves drawn from an easily parameterized distribution and then use the Maximum Likelihood Estimator (MLE) method to determine the parameters of the distribution. The MLE is the set of distribution parameters where the probability of the actual events turning out as they actually have turned out is higher than for any set of potential distribution parameters.

For example: Suppose the typical $1.00 slot machine gambler loses an average of $0.04 per gamble (this would be known either from knowledge of the slot machine's mechanics or from the preponderance of prior gambles data). Suppose we have a statistically significant population of gamblers with a known prior gambling sequence where we believe each gambler is governed by a two-stopping-rules behavior: When they reach their dollar-loss limit or time limit, whichever comes first, they will stop gambling. While we do know, for each past gamble sequence, the time and dollar loss (or gain) at the point the gambler stopped their sequence, we do not know which of the two allowed stopping reason actualized. Under this methodology, we presume that each gambler's stopping parameters is an independent random variable drawn from a parameterized distribution, for instance, the Normal distribution; where the two parameters are Mean and Standard Deviation. There are therefore four distribution parameters to be computed using the MLE (the mean and standard deviation of each of the two stopping parameters). (Note that a more nuanced model will also use MLE to identify the covariance matrix between the two stopping reasons). The stopping reason for each observation is then surmised as the one most likely in light of the now-known distribution from which they are drawn.

Correlation Algorithms: Under this class of algorithms, each parameter at the stopping point is modeled using the other parameters with standard correlation techniques (such as least square fit). For the two-stopping-reasons example above, for instance, a linear fit would be identified correlating gambling time and gambling losses at the point of stopping (identified in the example above as $0.04 per gamble). In this example, any gambler who stopped with losses exceeding $0.04 per gamble will be deemed to have stopped for dollar-limitation reason; any gambler who stopped with losses below $0.04 per gamble (or with a gain) will be deemed to have stopped for time-limitation reason.

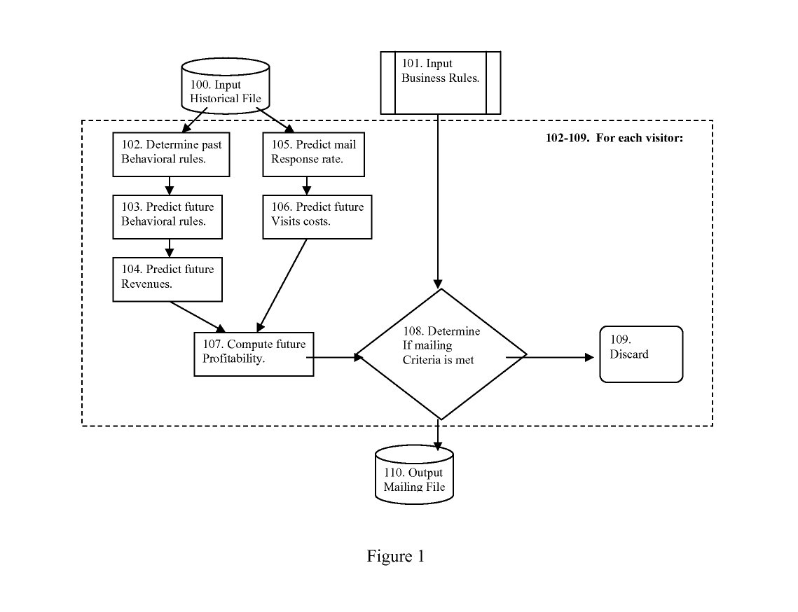

FIG. 1: Example Use of the Invention:

In this example, an input historical file (100) of past visitors and a predefined set of business rules (101) are used to generate an output mailing file (110) with the best prospects to invite to re-visit the casino.

The input to this process consists of two sources:
100: An input historical file (100) providing a record for each prior visitor to the casino. The record contains, at a minimum, data indicative of prior betting behavior as well as mail contact information.
101: Input business rules, a predefined process that mandates the minimum criteria for a mailing to be made. For example, the criteria may include minimum profitability, capacity limits of the facility, exclusion reasons (such as do-not-mail lists), and likewise.

In the example use of the invention, for each visitor, represented by one record in the input historical file (100), the following steps are performed:
102: Using the invention, past behavioral rules for the historical visitor are determined.
103: Using the invention, past behavioral rules for the historical visitor are used to statistically predict behavioral rules that will govern a future visit if that same visitor were to return.
104: Using standard probability computations, approximation, simulation, or likewise methodology; calculate the profitability of a future visit by the historical visitor that would be governed by the predicted behavioral rules (103).
105: Using standard mail responsiveness models, not specifically invented here, predict the incremental likelihood that the historical visitor will visit again if they receive a mail solicitation.
106: Using standard predictive modeling techniques, not specifically invented here, predict the incremental costs that will be incurred if the historical visitor were to accept a mail solicitation and visit the casino again.
107: Combine the expected profit computed in (104), the incremental probability of response computed in (105) and the incremental cost for a response (106) to generate a predicted overall profitability of mailing to the specific historical visitor.
108: Determine if the profitability computed in (107) meets the minimum required by the initial business rules (101) and if there are any other business rules (101) (such as do-not-mail status) that would exclude the historical visitor from being sent a mailing solicitation.
   109: If the historical visitor fails to meet the minimum criteria, then discard the historical visitor from the current mailing list (110).
   Otherwise, add the mailing information of the historical visitor to the current mailing list (110).

The output of this algorithm is a mailing file (110) containing the most profitable repeat visitor prospects.

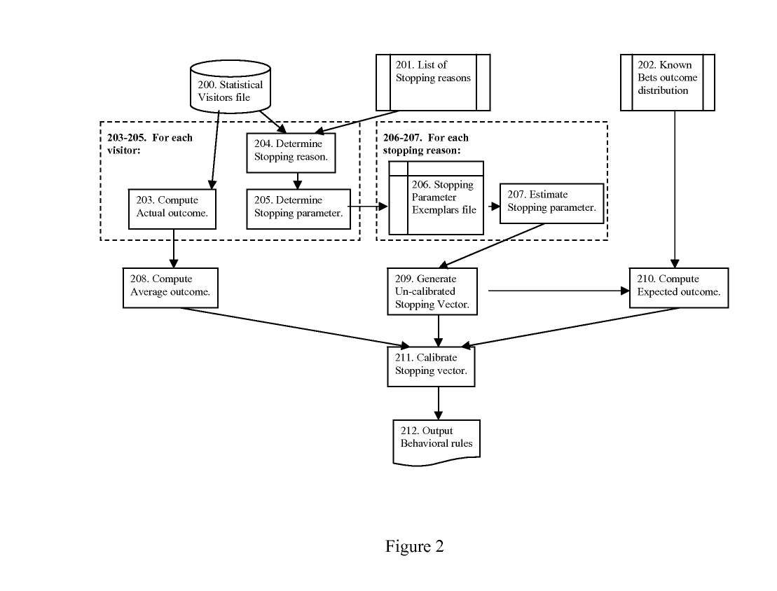

FIG. 2: The Invented Algorithm/Process:

The invented algorithm/process uses a file containing the detailed gambles of a statistically significant number of historical visits (200), a presumed list of potential stopping reasons (201), and the known distribution of bets outcome (203) to statistically surmise the governing behavioral rules (212).

The input to this process consists of three sources:
200: A file containing a statistically significant number of individual historical visits, where each record represents one historical visit, and containing, at a minimum, a complete capture of the pertinent elements of each bet made during the visit and the value of each potential stopping parameter at the conclusion of the visit. Ideally, all visits are presumed to be governed by the same behavioral rules. Alternatively, the behavioral rules are assumed to depend on a small number of measurable parameters.
201: A list of stopping rules and a defining parameter for each one. The behavioral rules will thus, effectively, be determined by the stopping parameter.
202: A known distribution of the outcome of each bet. The distribution is either known based on the specification of the gambling environment, or statistically derived from the historical examples (200).

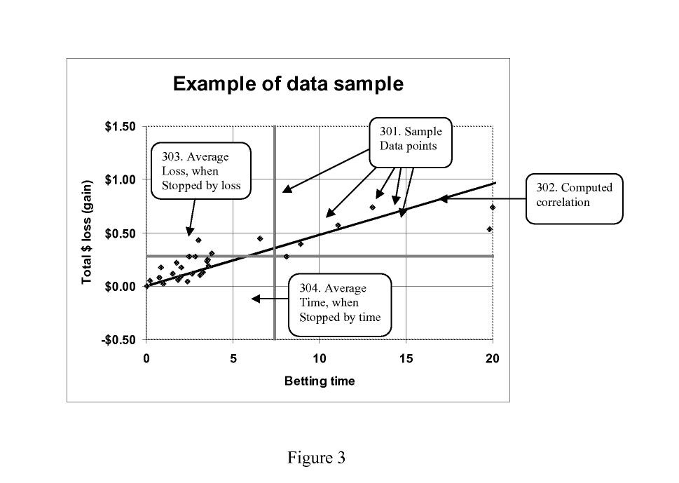

In the invented algorithm, for each historical visit, represented by one record in the input statistical visitors file (200), the following steps are performed:
203: The actual financial outcome of the visit (gain or loss to the casino) is computed.
204: From among all the allowed stopping reasons in (201), an algorithm is used to determine which stopping reason, in actuality, stopped the specific visit. The correlation algorithm described in FIG. 3, for example, may be used.
205: Assuming that the determined stopping reason in (204) was, indeed, the stopping reason for the specific visit, the corresponding stopping parameter is calculated and outputted to a file specific for that stopping reason (206).

In the invented algorithm, for each stopping reason identified in (201):
206: A file containing all the individual examples of the value of the stopping parameter, when the specific stopping reason was determined to have been actualized, is created by (205)
207: Using a standard statistical parameter estimation technique, for example taking the average, all the examples of the file (206) are combined into one estimated parameter. That parameter is the un-calibrated stopping parameter for that stopping reason.

In the invented algorithm, individually computed results for each visit and for each stopping reason are combined as follows:
208: The computed actual financial outcomes for all visits in the statistical sample (203) are combined using a standard statistical parameter estimation technique, for example taking the average, to calculate a universal average outcome parameter. This is the computed actual outcome.
209: The un-calibrated stopping parameter for each stopping reason, as computed in (207) are collected to form a vector (ordered list). That vector is the un-calibrated stopping vector.
210: Using the known distribution outcome of each bet (202), the expected financial outcome of a potential visit following the behavioral rules described by the un-calibrated stopping vector (209) is computed, approximated, simulated, or otherwise derived. This is the computed expected outcome.
211: The un-calibrated stopping vector computed in (209) is calibrated through a scalar normalization (multiplying all parameters by the same number—designated the calibration constant), such that the computed expected outcome (210) will equal the computed actual outcome (208). Any of many standard numerical approximation techniques, such as the Secant method, are used to find the calibration constant.
212: The final outcome of the algorithm is represented by the calibrated stopping vector (211).

The output of this algorithm is the computed behavioral rules (212) describing the visits in the statistical visitor file (200) represented as a series of stopping parameters (211).

FIG. 3: Example Application of the Correlation Algorithm/Process:

An example algorithm as required by (204) to determine the actual stopping reason for each historical visit example is the correlation algorithm.

The input to this example process is the same as for the Invented Algorithm (FIG. 2):
200: A file containing a statistically significant number of individual historical visits, and,
201: A list of stopping rules and a defining parameter for each one.

In the example algorithm, the data is analyzed by finding a statistical correlation between the stopping parameters. To illustrate, consider the example where there are only two allowed stopping parameters, such as “total losses” and “betting time,” thus allowing the correlation algorithm to be understood with the aid of a chart (the correlation algorithm itself requires no chart and is presented in a generalized fashion as to be applicable for any finite number of allowed stopping reasons).
301: Each data point, representing on historical visit in the statistical visitors file, is identified by the value of its various stopping parameters at the time the visit was stopped. In this example, the “total dollar losses” and the “total betting time” elapsed when the visit terminated.
302: A computed correlation is used to model each stopping parameter based on all other stopping parameters. Linear regression, or other modeling techniques, may be used. In this example, the “total dollar loss” is modeled as a regression versus “betting time.”
303: All data points where a specific stopping reason exceeds the modeled value by more than any other stopping reason, is designated as having that stopping reason actualized. In this example, all data points (301) above the correlation line (302) are designated as instances where the visit was stopped due to “total dollar loss.” The average dollar loss for those data points only is the estimated stopping parameter.
304: Likewise, in this example, all data points (301) below the correlation line (302) are designated as instances where the visit was stopped due to “total betting time.” The average betting time for those data points only is the estimated stopping parameter

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure as described above and below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method comprising:
receiving behavior rules corresponding to a plurality of gamblers;
defining a stopping vector for a select gambler aligned with the behavior rules;
apply a statistical or modeling technique to estimate the stopping vector; and
utilize the stopping vector to compute a wallet for the select gambler.
